(19) United States
(12) Patent Application Publication
(10) Pub. No.: US 2006/0011746 A1
(43) Pub. Date: Jan. 19, 2006

(54) Device to supply soap foam to the shower

(76) Inventor: Fiorentino De Simone, Roma (IT)

Correspondence Address: YOUNG & THOMPSON, 745 SOUTH 23RD STREET, 2ND FLOOR, ARLINGTON, VA, 22202, US

(21) Appl. No.: 10/533,404

(22) PCT Filed: Oct. 29, 2003
(86) PCT No.: PCT/IT03/00668

§ 371 Date: Apr. 29, 2005

(30) Foreign Application Priority Data
Oct. 29, 2002 (IT) RM2002A000543

(51) Int. Cl. A62C 5/00

(52) U.S. Cl. 239/311; 239/310; 239/318

(57) ABSTRACT

A device for ejecting foam from the shower head with controlled soap dosage is provided with elements to mix the water for the shower, already at the desired temperature, with air and a predetermined amount of soap, soap foam, shampoo and the like. Such device essentially includes one ore more reservoirs for liquid soap, elements to deliver a predetermined amount of liquid soap from such reservoirs, elements to intake air together with such amount of soap, and elements to mix soap and air sucked together with water before the latter is ejected from the shower head.

The present invention relates to the sanitary fitments particularly for shower.

It is well known that the detergent action of the soap or foam soap used while having a shower is often mitigated by that water from the shower head flows continuously to the skin and dilutes the detergent products.

To overcome such problems, a sponge soaked in liquid soap or foam soap is passed over the body to soap and clean it usually standing off the water jet.

In any case it is very difficult, or quite impossible, to use the right amount of soap or detergent product which is necessary to have a full wash. In most cases there is an unnecessary waste of soap and a not always uniform washing as well.

The main object of the present invention is to overcome such problems by providing a device suitable to mix on request a predetermined amount of soap with water from the shower head already at the desired temperature.

A second object of the invention is to provide soap water in the form of an uniform foam flowing directly from the shower head and giving a very pleasant soaping sensation.

This has been accomplished according to the invention by providing a device having means to mix the water for the shower, already at the desired temperature, with air and a predetermined amount off soap or soap foam in order to form a thick, uniform foam directly from the shower head.

A better understanding of the invention will follow from the following detailed description with reference to the accompanying drawings that show by way of a not limited example some preferred embodiments thereof.

In the drawings:

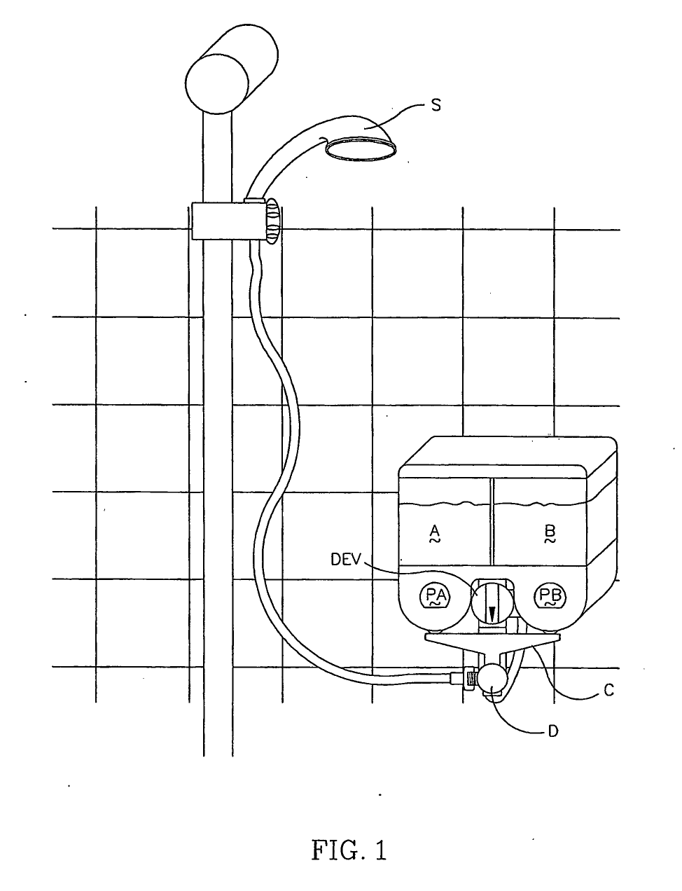

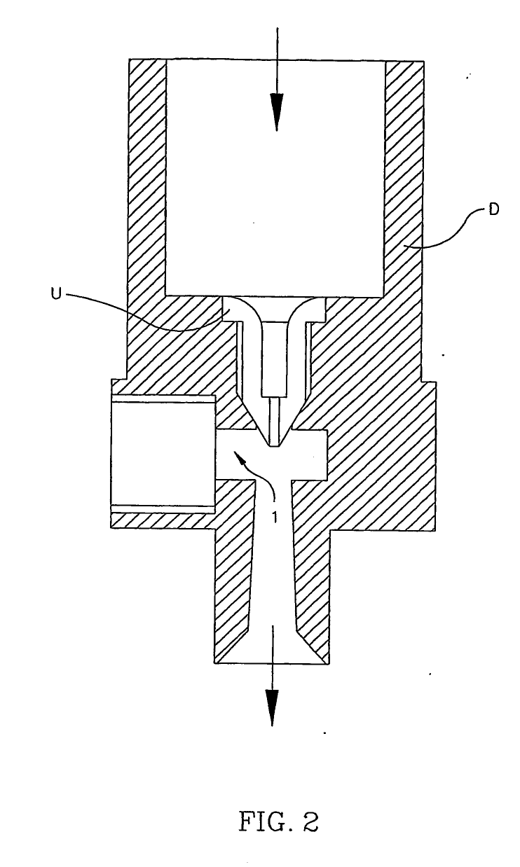

FIG. 1 is a perspective view showing schematically a first embodiment of the invention installed in a shower;

FIG. 2 shows schematically a longitudinal section of a detail of the first embodiment of the device according to the invention;

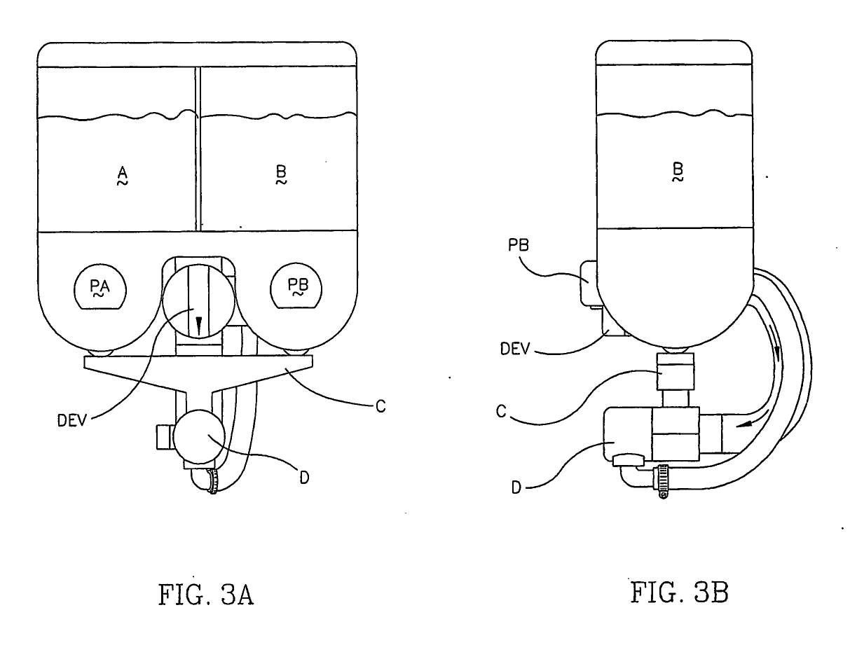

FIGS. 3A and 3B are front and side views of the invention of FIG. 1 during soaping, respectively;

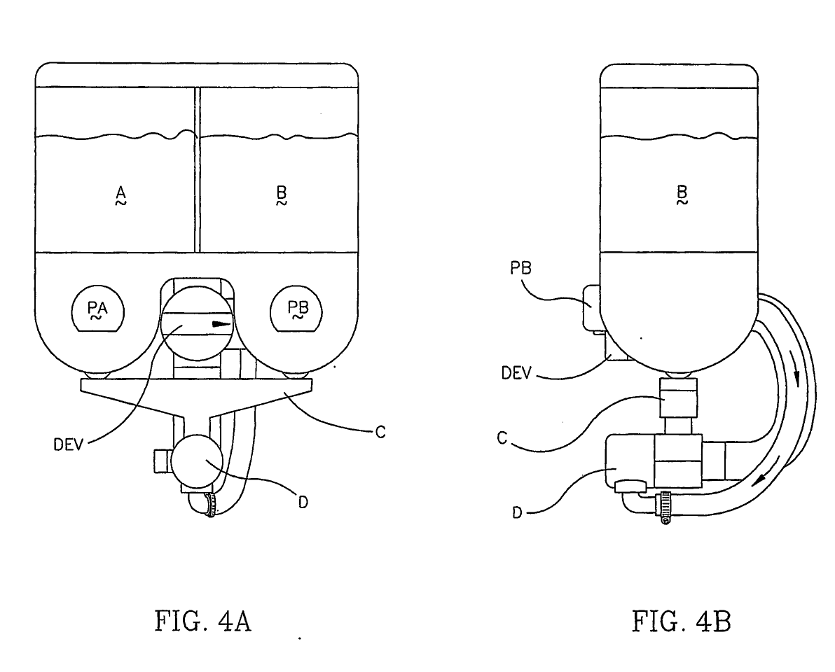

FIGS. 4A and 4B, similar to the preceding FIGS. 3A and 3B, show the invention during rinsing or washing;

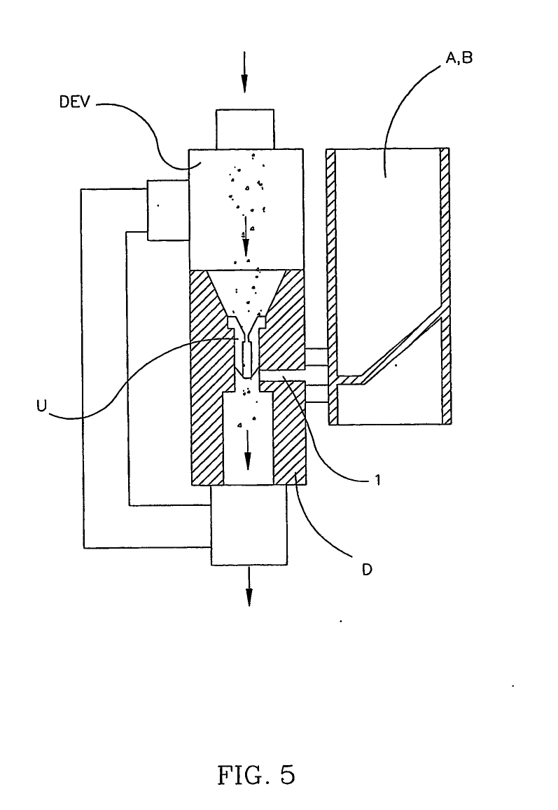

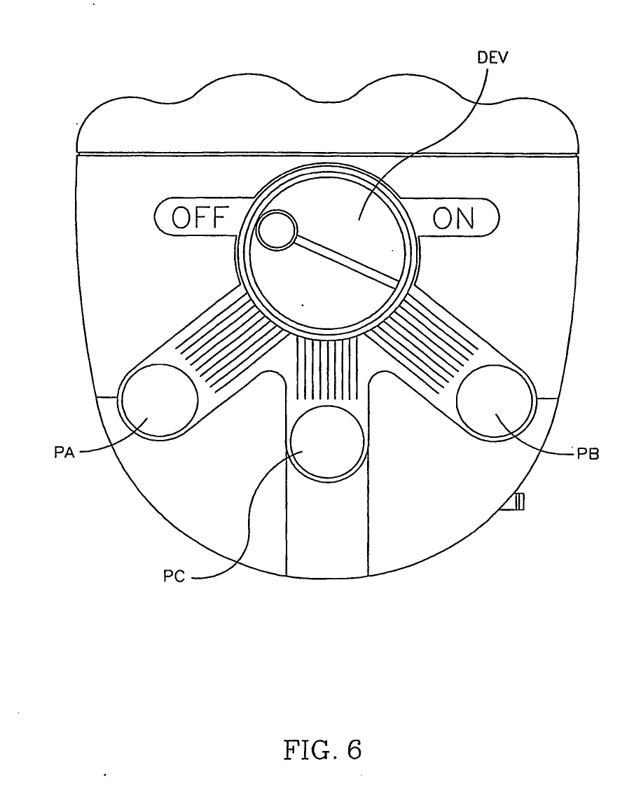

FIG. 5 shows schematically a variation of the device according to the invention;

FIG. 6 is a front elevation view of a first embodiment of the device with three reservoirs according to the invention;

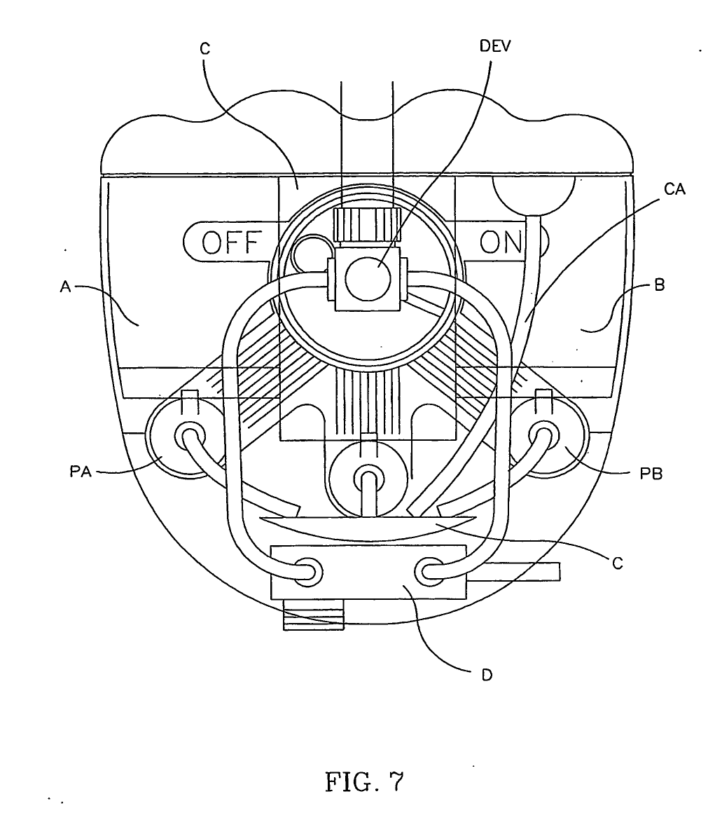

FIG. 7, similar to the preceding figure, is a half transparency view showing the inside of the invention;

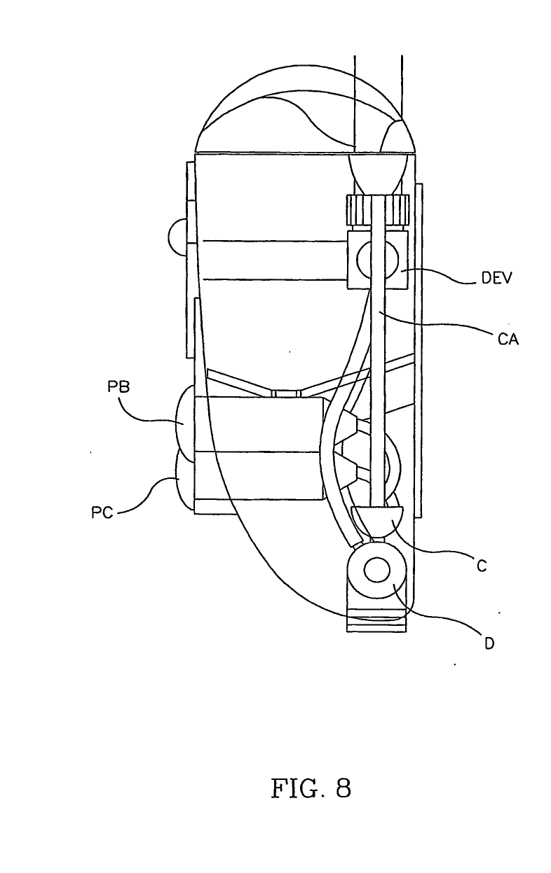

FIG. 8 is a side view of FIG. 7;

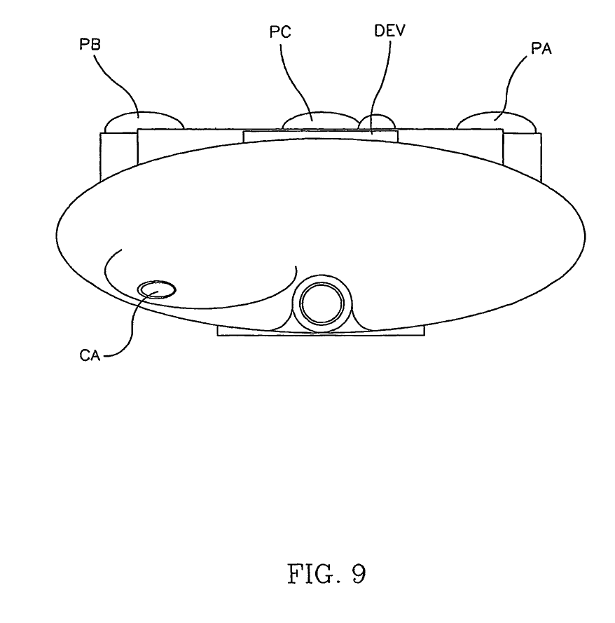

FIG. 9 is a top view of the embodiment of FIG. 6;

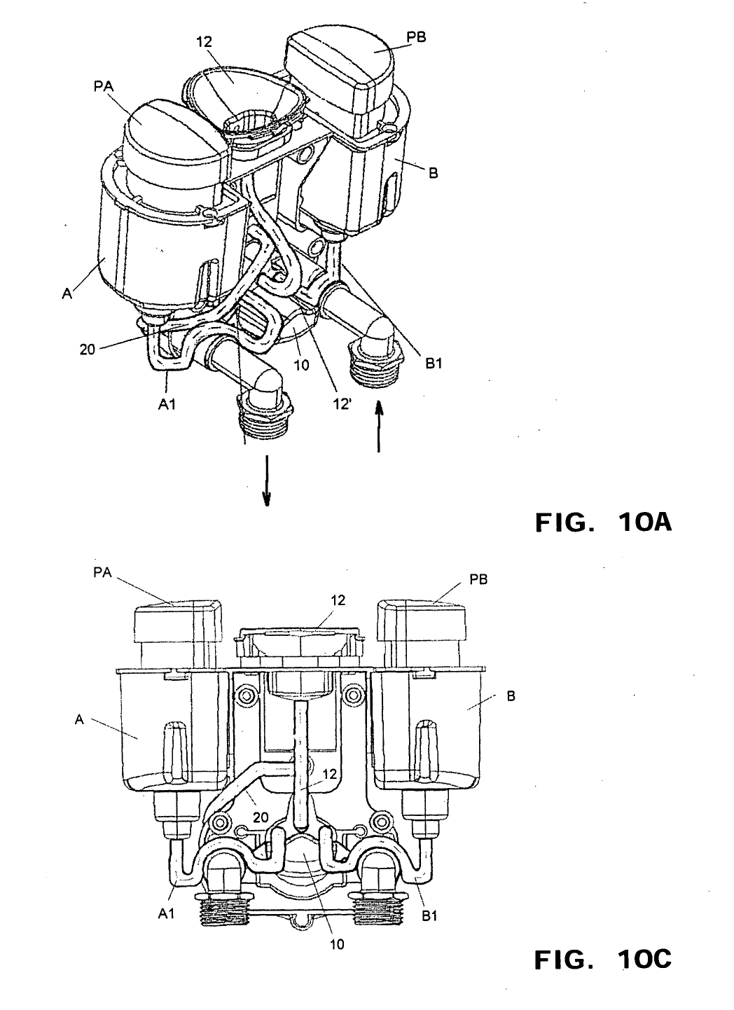

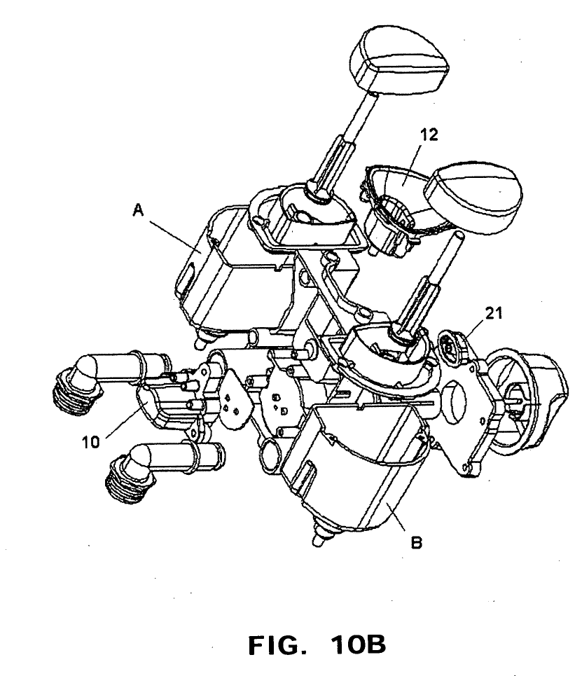

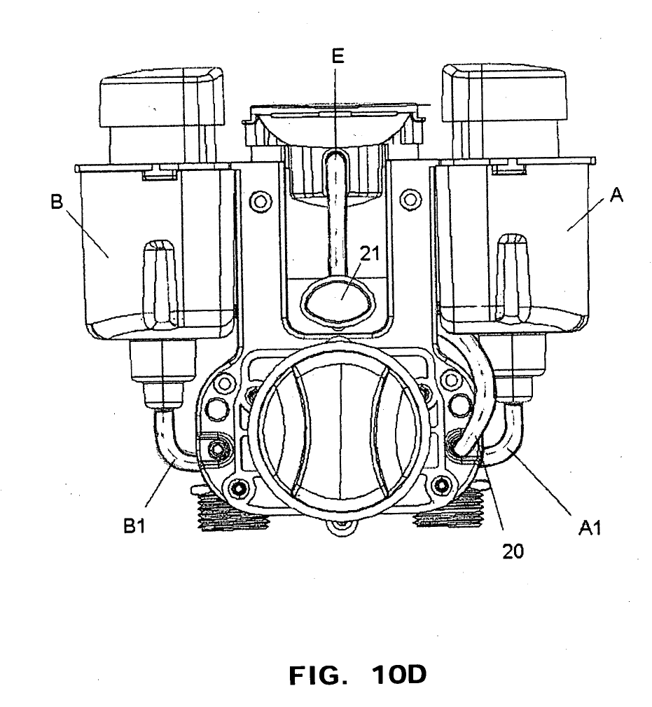

FIGS. 10A-10D show a three-dimensional view of a second embodiment of the device from different angles, in particular FIG. 10B is an exploded view showing also the inside parts;

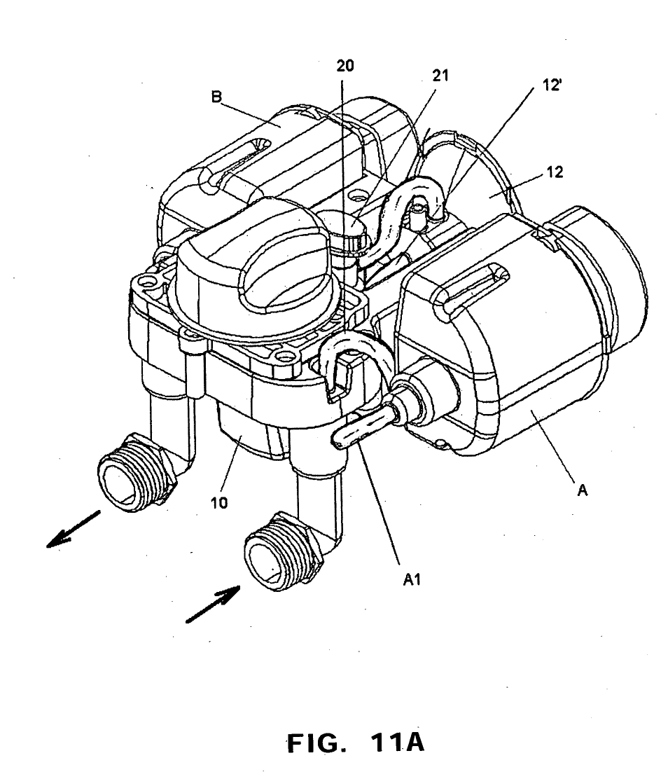

FIGS. 11A and 11B are three-dimensional views similar to the preceding figures showing the front side of the invention in assembled and exploded views, respectively;

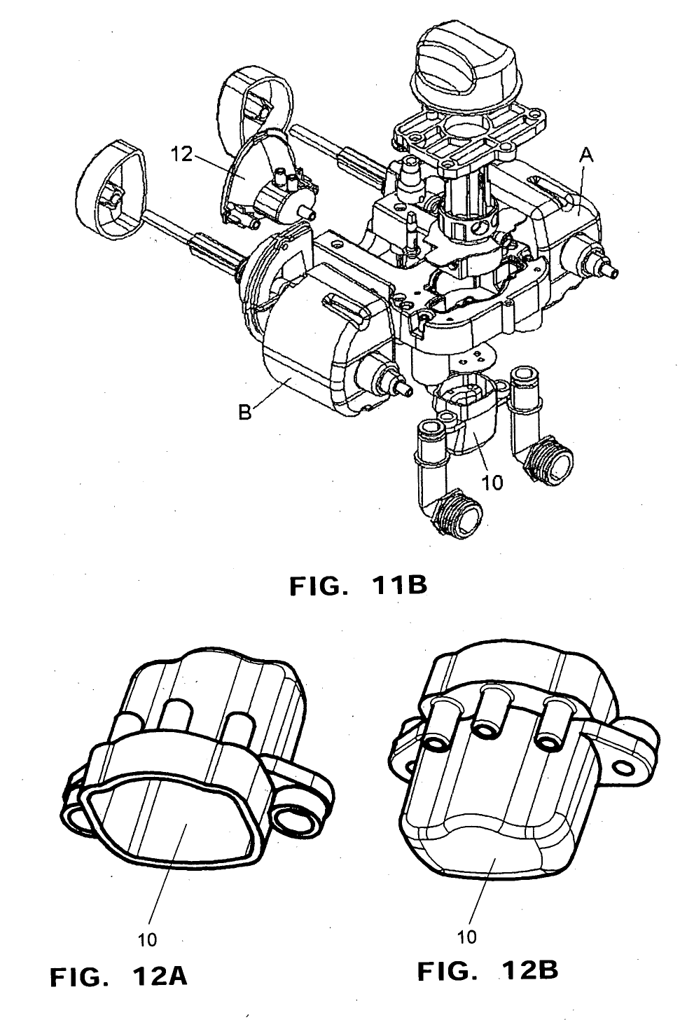

FIGS. 12A and 12B are three-dimensional views of the soap container which is connected to the mixing means and the upper air aspiration hopper;

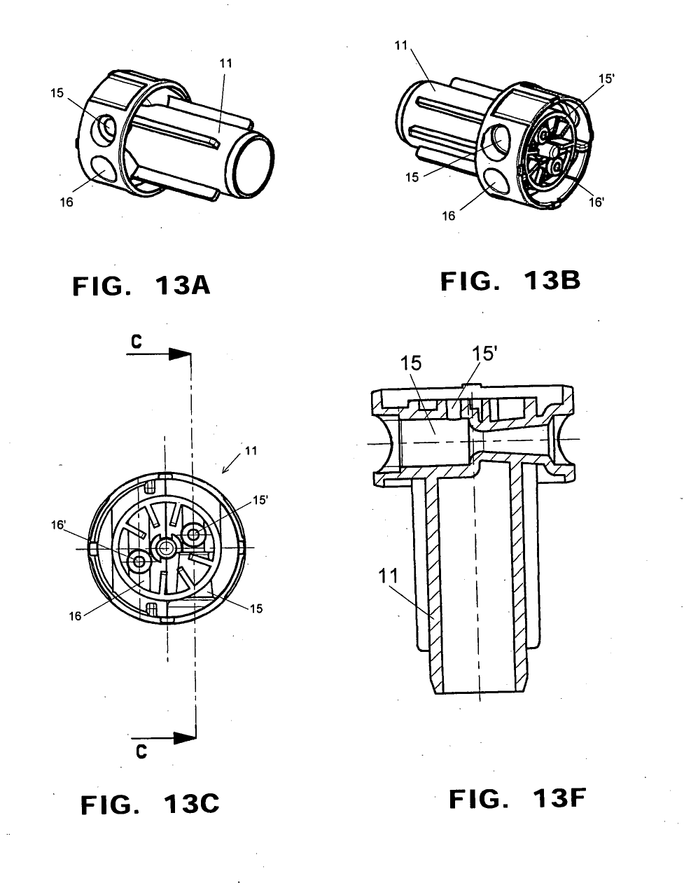

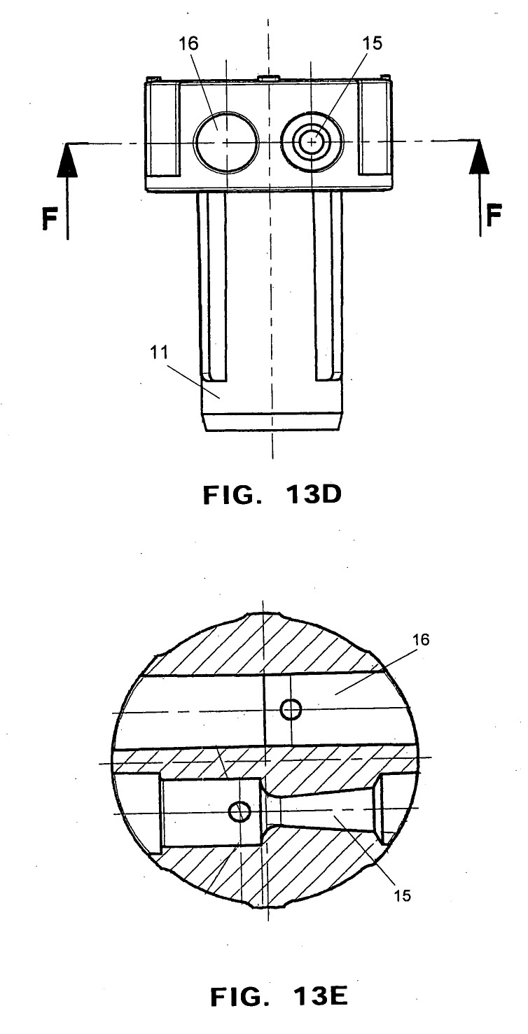

FIGS. 13A and 13B are three-dimensional views of the rotating switch of the second embodiment of the invention;

FIGS. 13C-13F show the switch of FIGS. 13A-13B according to different views and sections.

With reference to FIG. 1, the invention includes essentially at least one reservoir for the soap, means to deliver a predetermined amount of liquid soap from such- reservoir, means to intake air together with such amount of soap, and means to mix soap and air sucked together with water which is already at the temperature desired by the user before supplying it to the shower head.

In the embodiment shown, the device has two side by side reservoirs A and B able to contain two types of soap or a foam soap and a shampoo, etc.

When a predetermined amount of soap is delivered from the respective reservoir A (or B) by pushing a control pushbutton PA (or PB), the same falls to a conveyer C preferably placed under the reservoirs and consisting of a small funnel or hopper and flows inside it until the input of the above-mentioned suction means is reached.

According to a peculiar feature of the present invention, such suction and mixing means consist of a diluter-mixer D (FIG. 2) including preferably a Venturi tube which, as known, creates a depression when it is crossed longitudinally by the pressurized water flow at the temperature of use causing soap and air to be sucked from suction pipe 1, the input of which is connected from the outside to the lower base of the already mentioned conveyer C. As a consequence of the above, the soap water comes out of the diluter D and reaches the shower head in the form of a mix of foam and liquid through a hose of the known type.

The intake rate at which soap and air are sucked through suction pipe 1 can be adjusted advantageously by arranging suitable means of the known type to displace nozzle U back and forth to the axial direction so as to change its position with respect to the longitudinal axis of suction pipe 1.

According to the invention, the disclosed device includes further a switch DEV controlled by the user and able to supply water, already at the temperature of use, alternately to diluter D or directly to the shower head, thus bypassing diluter D.

FIGS. 3B and 4B show the two alternative paths of water through diluter D and directly to the shower head S, respectively.

With particular reference to FIG. 2, diluter D is provided with a nozzle U which reduces the section of the input water flow to the suction pipe which intakes liquid soap and air to form a foam fed by the diluter to the shower head.

In the preferred embodiment disclosed, suction pipe I is provided with a check valve (not shown) which allows soap and air to enter diluter D during the suction only, and at the same time prevents water from being fed by the suction pipe when the switch is in the rinsing position.

A further peculiar feature of the invention is given by the particular function of conveyer C. In fact, it should be appreciated that liquid soap, soap foam, and shampoo generally have a high viscosity and then their flow to the lowest portion of conveyer C at the input to suction pipe 1 is not rapid (as it is the case, for example, in less viscous liquids such as water) so that the intake through pipe 1 produced by Venturi tube causes air to be sucked together with soap, thus allowing the formation of foam within the soap water that reaches shower head S.

To this end, the inside walls of conveyer C have an inclination with respect to the horizontal which is preferably lower than or equal to 30°.

According to the invention it is also provided that the inside of conveyer C is shaped stepwise so that the soap is caused to slow down towards the suction pipe 1 at the base of the conveyer.

Moreover, the amount of soap sticking spontaneously to the inner walls of conveyer C comes down slowly to suction pipe 1 and allows advantageously the formation of foam and the consequent soaping effect to be protracted.

Finally, it should be just appreciated that in case switch DEV is set in the bypass position of diluter D, the shower operates in the same way as the conventional showers

FIGS. 1 to 4B show a preferred embodiment in which diluter-mixer D is disposed horizontally but according to a first variation of the invention shown in FIG. 5 it is also possible to dispose diluter-mixer D vertically, achieving in any case the same efficiency. In addition, the same inventive concept can also be applied without any variation to more reservoirs of liquid soap, shampoo or other detergent product, each of them pours out the dose of liquid inside conveyer C.

The diameter of suction pipe 1 or its input hole is as large as 0.7 to 1.9 mm, preferably 1 to 1.3 mm.

In addition to suction pipe 1, a second embodiment of the invention is provided with a further suction pipe having a very short diameter, preferably lower than or equal to 1 mm, which connects the outside to suction pipe 1 or the area near the outlet of nozzle U so as to guarantee the continuous intake of air by diluter-mixer D, thus mitigating the soap and air suction through pipe 1.

Such further air suction pipe with small diameter can have means of the known type to adjust its opening so as to change at will the amount of water which is sucked through it and then also the amount of the air and soap suction force of suction pipe 1.

A third embodiment of the invention (FIGS. 6-9) is further provided with a small pipe or additional pipe CA separated from the soap reservoirs and particularly suitable to carry substances added extemporaneously by the user, such as essential oils, smelling essences, etc., directly to conveyer C. Such additional pipe CA is preferably connected to a small recess formed in the lid of such soap reservoirs in which the user pours the desired smelling essence or the essential oil so that it can be sprinkled to his or her body together with water from shower.

Advantageously, such additional pipe CA allows the walls of conveyer C to be rinsed away of soap stuck thereto so as to use completely the soap and to prevent deposits that could encrust the conveyer over time, thus compromising the operation of-the device.

It should be noted that owing to the complete use of soap and to the fact that it is not necessary anymore to stand aside from the water jet of the shower during the soaping, the invention allows to save soap by about 40% and water by about 30%, thus contributing to reduce environment pollution and waste of water.

FIGS. 6 to 9 show an embodiment with three reservoirs PA, PB, PC (for example two soap foam for shower and one shampoo) which is provided with additional pipe CA connected at the upper side to a recess arranged in the lid.

A second embodiment shown in Figures from 10A on illustrates a device of the above-described type in which switch 11, instead of switching the path of water to feed it to Venturi tube 15 or directly to the shower head, displaces the same Venturi tube 15 and a corresponding length of a free duct 16 so that water already at the desired temperature can flow alternately therein.

It is self-evident from the above that, when switch 11 is in the position in which water flows through Venturi tube 15, soap and air are sucked so that a foam soaping the user is streaming of the shower, and when switch 11 is in the position in which water flows through the length of free duct 16, water streaming out of the shower is not mixed with soap and the user can rinse himself.

In the disclosed embodiment, the device is provided with two reservoirs A and B with meter for soap, shampoo, balsam or other detergent liquid, the output pipes of which A1 and B1 are connected to a reservoir or tank 10 from which Venturi tube 15 intakes directly soap and air during the operation, air reaching this reservoir or tank 10 through a further pipe 12′ which is connected to an upper hopper 12 in the open air. Advantageously, this hopper 12 can also be used by the user to pour smelling essences or essential oils that will be sprinkled to his or her body at the end of the shower, or to use temporarily a detergent liquid different from those contained in reservoirs A and B.

When the user changes switch 11 over the opposite position, thus bypassing Venturi tube 15 and adding the length of duct 16 to the path of water at the desired temperature, such length of free duct 16 is connected according to the invention to reservoir 10 of liquid soap (from which Venturi tube 15 exerted its suction action during its operation) so that while the user is rinsing himself or herself at the end of his or her taking a shower, a little amount of water without soap flows continuously in the opposite direction into reservoir 10 and through pipe 12′ which connects it to the upper hopper 12 so that water overflows from the latter and outside the device.

Because of such contrivance a complete and effective washing and rinsing of the device is accomplished so that traces of the detergent products used before whose essences or type could not be enjoyed by the following user of the device are not present at every use.

With particular reference to FIGS. 13A-13F the diameter of the connecting pipe 15′ between Venturi tube 15 and reservoir 10 and the diameter of the connecting duct 16′ between the latter and the length of free duct 16 is, for example, 1/10 to ⅓ as large as the diameter of Venturi tube 15 or free duct 16.

As can be clearly seen from FIGS. 13A-13B, switch 11 has an essentially cylindrical body including both Venturi tube 15 and the length of the free duct 16 parallel to each other and provided with a suction orifice 15′ connected to reservoir 10 shown in FIGS. 12A and 12B and an inlet orifice 16′ connected to the same non-soaped water reservoir, respctively. From the foregoing it is evident that both soaping and rinsing positions are set by rotating by 180° switch 11 which connects alternately Venturi tube 15 or the length of free duct 16 to the water circuit.

In particular, the longitudinal axes of such Venturi tube and such length of free duct included in the switch are perpendicular to the axis of the switch and spaced uniformly therefrom.

According to the invention a partial recycling of the soaped water can be provided so that the dilution of the soap is increased. To this end, a further pipe 20 is provided with a very small section, for example 1/10 to ⅓ as small as that of the water outlet pipe connected to the shower head, such pipe “tapping” the partial amount of water mentioned above from the outlet pipe and feeding it directly to the lower portion of air suction hopper 12 through which such recycling water amount is sucked by Venturi tube 15 again and mixed to the detergent product and the inlet water.

Of course, such recycling can be continuous but also be controlled by the user by a suitable knob 21 located between the tapping orifice and the upper hopper 12.

A simplified variation of this second embodiment of the invention is without the two reservoirs A and B for the detergent liquid, and the user pours every time the desired product into upper hopper 12 connected to the reservoir the content of which is sucked directly by Venturi tube 15 together with air.

The present invention has been described and illustrated according to some preferred embodiments and variations thereof, however, it should be understood that those skilled in the art can make a number of functionally and/or technically equivalent modifications without departing from the scope of the present industrial invention.

Further variations can provide, for example, several air and soap suction orifices that can be coincident or separate, and needle means to unclog nozzle U in case of clogging which can be of course made in one piece with the body of diluter D.

Furthermore, the water pipe at the temperature of use can be passed above conveyer C and be provided with at least one hole or slot above the latter to cause a very little amount of water to drip into the conveyer so as to rinse advantageously the inner walls thereof from the soap.

1. A device for supplying foam to a shower head with controlled soap dosage, characterized in that there is provided means to mix the water for the shower, already at the desired temperature, with air and a predetermined amount of soap, soap foam, shampoo and the like in order to form a thick, uniform foam directly ejected from the shower head.

2. The device according to claim 1, characterized in that there is essentially included one ore more reservoirs for liquid soap (A, B), means (PA, PB) to deliver a predetermined amount of liquid soap from such reservoirs, means to intake air together with such amount of soap, and means to mix soap and air sucked together with water before the latter is ejected from the shower head.

3. The device according to claim 2, characterized in that each reservoir (A, B) is provided with a respective control pushbutton (PA, PB) controlling means of the known type to deliver a predetermined amount of soap from the respective reservoir, thus causing the soap to fall to a suitable conveyer (C) placed under the reservoirs and consisting of a small funnel or hopper and to flow inside it until the input of said suction means is reached.

4. The device according to claim 3, characterized in that said suction means and said mixing means consist of a diluter-mixer (D) including a Venturi tube which creates a depression when it is crossed longitudinally by the pressurized water flow at the temperature of use causing soap and air to be sucked from the suction pipe (1) the input of which is connected from the outside to the lower base of the conveyer (C), thus causing the soap water to come out of diluter (D) and to reach the shower head in the form of a mix of foam and liquid through a hose of the known type.

5. The device according to claim 4, characterized in that there is provided a switch (DEV) controlled by the user and able to switch water, already at the temperature of use, alternately to diluter (D) or directly to the shower head, thus bypassing the diluter for rinsing.

6. The device according to claim 4, characterized in that diluter (D) is provided with a nozzle (U) which reduces the section of the input water flow to the suction pipe (1) which intakes liquid soap and air to form a foam fed by the diluter to the shower head.

7. The device according to claim 5, characterized in that suction pipe (1) is provided with a check valve which allows soap and air to enter diluter (D) during the suction only, and at the same time prevents water from being fed by the suction pipe when switch (DEV) is the rinsing position.

8. The device according to claim 4, characterized in that in order to cause the flow of soap or shampoo to the lowest portion of conveyer (C) at the input of suction pipe (1) to be slow enough so that the intake through pipe 1 causes air to be sucked together with soap, thus allowing the formation of foam within the soap water that reaches shower head (S), the inside walls of conveyer (C) have an inclination with respect to the horizontal which is lower than or equal to 30+.

9. The device according to claim 8, characterized in that the inside of conveyer (C) is shaped stepwise so that the soap is caused to slow down towards the suction pipe (1) at the base of the conveyer.

10. The device according to claim 4, characterized in that diluter-mixer (D) is placed either horizontally or vertically, achieving in any case the same efficiency.

11. The device according to claim 4, characterized in that the diameter of the suction pipe (1) or its input hole is as large as 0.7 to 1.9 mm, preferably 1 to 1.3 mm.

12. The device according to claim 6, characterized in that in addition to suction pipe (1) there is also provided a further secondary suction pipe having a diameter lower than or equal to 1 millimetre, which connects the outside to suction pipe (1) or the area near the outlet of nozzle U so as to guarantee the continuous intake of air by diluter-mixer D, even if a large amount of liquid is collected at the bottom of conveyer (C), thus mitigating the soap and air suction through pipe (1).

13. The device according to claim 3, characterized in that there is provided a small pipe or additional pipe (CA) separated from the soap reservoirs and particularly suitable to carry substances added extemporaneously by the user, such as essential oils, smelling essences, etc., directly to conveyer (C), said additional pipe (CA) being connected to a small recess formed in the lid of said soap reservoirs in which the user pours the desired smelling essence or the essential oil so that it can be sprinkled to his or her body together with water from shower.

14. The device according to claim 1, characterized in that several air and soap suction orifices are provided that can be coincident or separated.

15. The device according to claim 6, characterized in that needle means are provided to unclog nozzle (U) in case of clogging which can be of course made in one piece with the body of diluter (D).

16. The device according to claim 6, characterized in that the intake rate at which soap and air are sucked through suction pipe (1) can be adjusted by arranging suitable means of the known type to displace nozzle (U) back and forth to the axial direction so as to change its position with respect to the longitudinal axis of suction pipe (1).

17. The device according to claim 12, characterized in that said further secondary air suction pipe is provided with means of the known type to adjust its opening so as to change at will the amount of water which is sucked through it and then also the amount of the air and soap suction force of suction pipe (1).

18. The device according to claim 2, characterized in that each reservoir (A, B) is provided with a respective control pushbutton (PA, PB) which operates means of the known type to deliver a predetermined amount of soap, shampoo, balsam or other detergent liquid, and includes an output pipe connected to a reservoir or tank from which the mixing means intakes directly soap and air during the operation, the air reaching this reservoir or tank through a further pipe which is connected to an upper hopper in the open air.

19. The device according to claim 18, characterized in that said hopper can also be used by the user to pour smelling essences or essential oils so that they can be sprinkled to his or her body at the end of his or her taking a shower, or temporarily a detergent liquid different from those contained in the reservoirs.

20. The device according to claim 19, characterized in that said mixing means consists of a Venturi tube arranged in a rotating switch (11) together with a corresponding length of free duct, the water flow which is already at the desired temperature flowing alternately through said Venturi tube or said length of free duct.

21. The device according to claim 20, characterized in that switch (11) has an essentially cylindrical body including both Venturi tube and the length of the free duct parallel to each other and provided with a suction orifice connected to the reservoir and an inlet orifice connected to the same non-soaped water reservoir, respectively, both soaping and rinsing positions being set by rotating by 180° the switch which connects alternately Venturi tube or the length of free duct to the water circuit.

22. The device according to claim 21, characterized in that the longitudinal axes of said Venturi tube and said length of free duct included in the switch are perpendicular to the axis of the rotating switch and spaced uniformly therefrom.

23. The device according to claim 22, characterized in that when rotating switch (11) is in the position in which water flows through Venturi tube, soap and air are sucked so that a foam soaping the user is streaming of the shower, and when switch is in the position in which water flows through the length of free duct, water streaming out of the shower is not mixed with soap and the user can rinse himself.

24. The device according to claim 23, characterized in that said length of free duct is connected to liquid soap reservoir (from which Venturi tube exerted its suction action during its operation) so that when the user set the switch to the rinsing position, thus bypassing the Venturi tube and adding the length of tube to the path of water at the desired temperature, a little amount of water without soap flows continuously in the opposite direction into reservoir and through the duct which connects it to the upper hopper so that water overflows from the latter and outside the device, thus accomplishing a complete and effective washing and rinsing of the device so that traces of the detergent products used before whose essences or type could not be enjoyed by the following user of the device are not present at every use.

25. The device according to claim 24, characterized in that the diameter of the connecting pipe between the Venturi tube and the reservoir and the diameter of the connecting pipe between the latter and the length of the free duct are, for example, 1/10 to ⅓ as large as the diameter of Venturi tube or the free duct.

26. The device according to claim 24, characterized in that in order to provide a partial recycling of the soaped water so that the dilution of the soap is increased, a further pipe is provided with a very small section, preferably 1/10 to ⅓ as small as that of the water outlet pipe connected to the shower head, such pipe “tapping” the partial amount of water mentioned above from the outlet pipe and feeding it directly to the lower portion of air suction hopper 12 through which such recycling water amount is sucked by the Venturi tube again and mixed to the detergent product and the inlet water.

27. The device according to claim 26, characterized in that said recycling is controlled by the user by a suitable knob located between the tapping orifice and the upper hopper.

28. The device according to claim 18, characterized in that as an alternative to the two reservoirs for the soap or detergent liquid, there is only provided the upper hopper connected directly to the reservoir the content of which is sucked by the mixing means together with air.
